(19) United States
(12) Patent Application Publication
(10) Pub. No.: US 2007/0024245 A1
(43) Pub. Date: Feb. 1, 2007

(54) POWER SUPPLY APPARATUS AND A VEHICLE HAVING A POWER SUPPLY APPARATUS

(75) Inventor: Douglas Zhu, Canton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/161,375

(22) Filed: Aug. 1, 2005

(51) Int. Cl. H02J 7/04

(52) U.S. Cl. 320/150

(57) ABSTRACT

A power supply apparatus for a vehicle is provided. The power supply apparatus comprises a first battery pack and a second battery pack. The power supply apparatus also comprises a first fan proximate to the first battery pack and a second fan proximate to the second battery pack. The power supply apparatus can extend battery life and increase performance through the independent cooling of the first and second battery pack.

### BACKGROUND OF THE INVENTION

1. Field of the Invention

This invention relates to a power supply apparatus and a vehicle having a power supply apparatus.

2. Background Art

A power supply apparatus may contain batteries. Several factors influence the operating temperature of a battery within a power supply apparatus. For example, the heat generated by a battery for a given current may change over time because the internal resistance of the battery may increase due to aging. Also, a battery located closer to an engine in a vehicle may be exposed to more heat than a battery located further from the engine.

Because performance can degrade when batteries of a power supply apparatus do not have similar operating temperatures, forced cooling is helpful in an environment where the power supply apparatus contains a large mass of batteries packaged within a space restricted environment.

When batteries are configured as two electrically connected battery packs, the differences in operating temperatures of the batteries of each respective battery pack can cause different forced cooling requirements between the battery packs. Thus, two (2) battery packs may experience inefficient cooling when cooled by a single fan. The present invention overcomes inefficient cooling by independently cooling each of the battery packs.

### SUMMARY OF THE INVENTION

An object of the present invention is to provide a power supply apparatus which can extend battery life and increase performance through the independent cooling of two (2) battery packs.

A further object of the present invention is to provide a desired air flow to at least some of the batteries of the power supply apparatus.

### BRIEF DESCRIPTION OF THE DRAWINGS

FIG. 1 is a schematic representation of an exemplary vehicle powertrain system in accordance with the present invention;

FIG. 2 is a plan view of an embodiment of a power supply apparatus of the powertrain system of FIG. 1;

FIG. 3 is a perspective view of the embodiment of the power supply apparatus of FIG. 2;

FIG. 3A is a cross section of the embodiment of the power supply apparatus of FIG. 3;

FIG. 4 is a perspective view of an alternative embodiment of the power supply apparatus of FIG. 2;

FIG. 4A is a cross section of the embodiment of the power supply apparatus of FIG. 4;

FIG. 5 is an enlarged cross section of the embodiment of the power supply apparatus of FIG. 3;

FIG. 6 is an enlarged cross section of the embodiment of the power supply apparatus of FIG. 4;

FIG. 7 is a further enlarged cross section of the embodiment of the power supply apparatus of FIG. 5; and

FIG. 8 is an enlarged cross section of an alternative embodiment of FIG. 5.

### DETAILED DESCRIPTION OF THE PREFERRED EMBODIMENT(S)

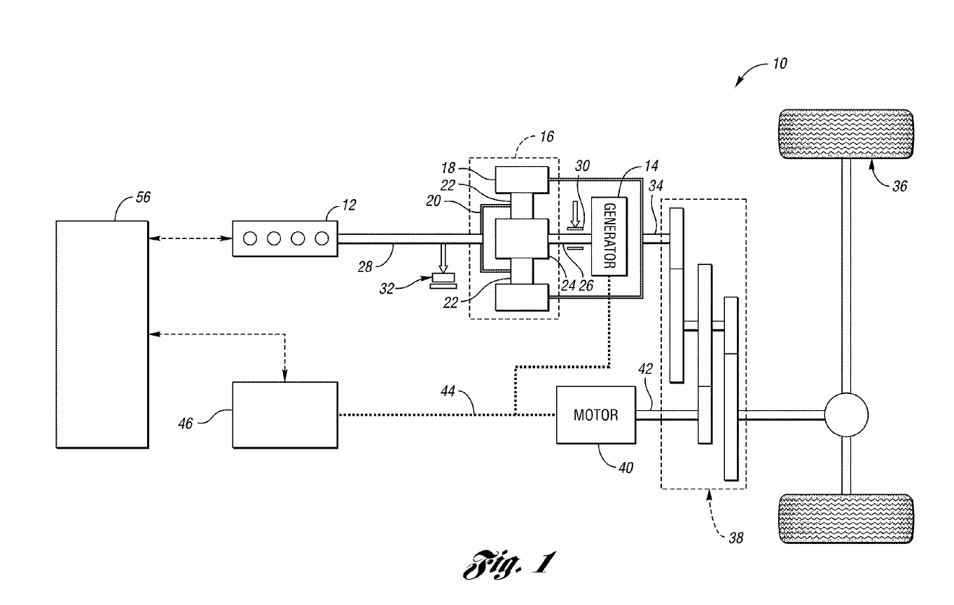

FIG. 1 shows a schematic representation of a vehicle 10 in accordance with one embodiment of the present invention. The vehicle 10 includes an engine 12 and an electric machine, or generator 14. The engine 12 and the generator 14 are connected through a power transfer unit, which in this embodiment is a planetary gear set 16. Of course, other types of power transfer units, including other gear sets and transmissions, may be used to connect the engine 12 to the generator 14. The planetary gear set includes a ring gear 18, a carrier 20, planet gears 22, and a sun gear 24.

The generator 14 can also be used as a motor, outputting torque to a shaft 26 connected to the sun gear 24. Similarly, the engine 12 outputs torque to a shaft 28 connected to the carrier 20. A brake 30 is provided for stopping rotation of the shaft 26, thereby locking the sun gear 24 in place. Because this configuration allows torque to be transferred from the generator 14 to the engine 12, a one-way clutch 32 is provided so that the shaft 28 rotates in only one direction. Having the generator 14 operatively connected to the engine 12, as shown in FIG. 1, allows the speed of the engine 12 to be controlled by the generator 14.

The ring gear 18 is connected to a shaft 34, which is connected to vehicle drive wheels 36 through a second gear set 38. The vehicle 10 includes a second electric machine, or motor 40, which can be used to output torque to a shaft 42. Other vehicles within the scope of the present invention may have different electric machine arrangements, such as more or less than two electric machines. In the embodiment shown in FIG. 1, the motor 40 and the generator 14 can both be used as motors to output torque. Alternatively, each can also be used as a generator, outputting electrical power to a high voltage bus 44 and to an energy storage device, or power supply apparatus 46. The power supply apparatus 46 is a high voltage energy source capable of outputting electrical power to operate the motor 40 and the generator 14.

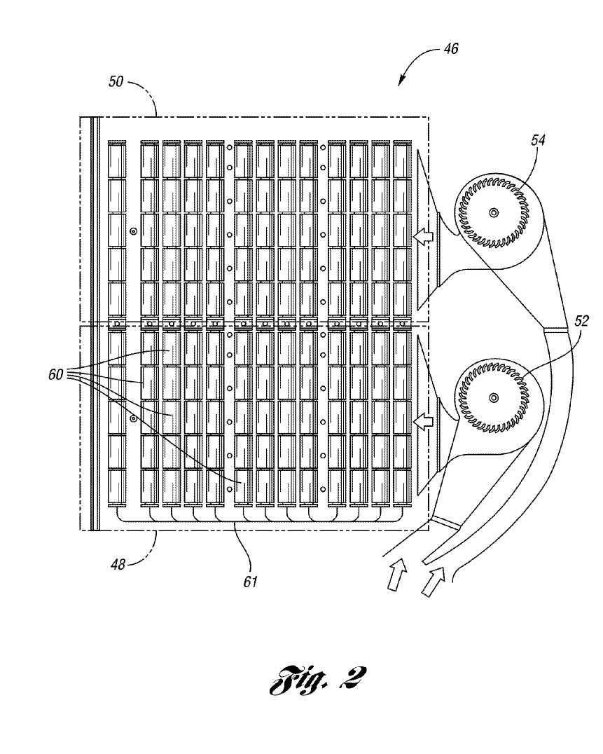

The power supply apparatus 46 includes a plurality of electrical storage units, which, by way of example and not limitation, are shown in FIG. 2 as first and second battery packs 48, 50. The temperature of the first battery pack 48 may differ from that of the second battery pack 50 because of, for example, the location of the battery packs 48, 50 within the vehicle 10 (FIG. 1). The first battery pack 48 is cooled by a first cooling device, or first fan 52. The second battery pack 50 is cooled by a second cooling device, or second fan 54. The fans 52, 54 can be controlled independently by controller 56 (FIG. 1). The controller 56 may use information supplied by temperature sensors (not shown) located proximate the battery packs 48, 50 to control the fans 52, 54. Alternatively, the controller 56 may estimate the temperature of the battery packs 48, 50 from other information received from other sensors and/or devices.

Independent control of the fans 52, 54 provides for different levels of cooling depending on the respective temperatures of the battery packs 48, 50. In use, there may be temperature variations between the two battery packs 48, 50. Independent cooling of the battery packs 48, 50 helps to ensure that each of them receives the cooling it needs; it also saves energy by not providing cooling to a battery pack 48, 50 that does not require it. Effectively maintaining the operating temperatures of the batteries 60 of each respective battery pack 48, 50, may increase the overall performance of the power supply apparatus 46. Overall energy consumption can also be reduced by the elimination of unnecessary cooling.

The battery pack 48 includes a plurality of batteries 60 arranged in modules 61. A module 61 consists of five (5) batteries connected in series. The number of batteries 60 and the manner of electrically connecting the batteries 60 can vary as desired. Configuring a module 61 with five (5) batteries, however, allows for the efficient identification of a battery that is operating outside of its desired range. Individually monitoring the performance of each battery 60 of the battery pack 48 may be cost prohibitive, whereas only monitoring the performance of the entire battery pack 48 may not identify which of the batteries 60 may be operating outside of its desired range. By monitoring the performance of a module 61, only a limited number of batteries 60 need to be examined when the module 61 is operating outside of its desired range. The battery pack 50 is similarly configured to the battery pack 48, and is electrically connected to the battery pack 48 in a manner consistent with the art.

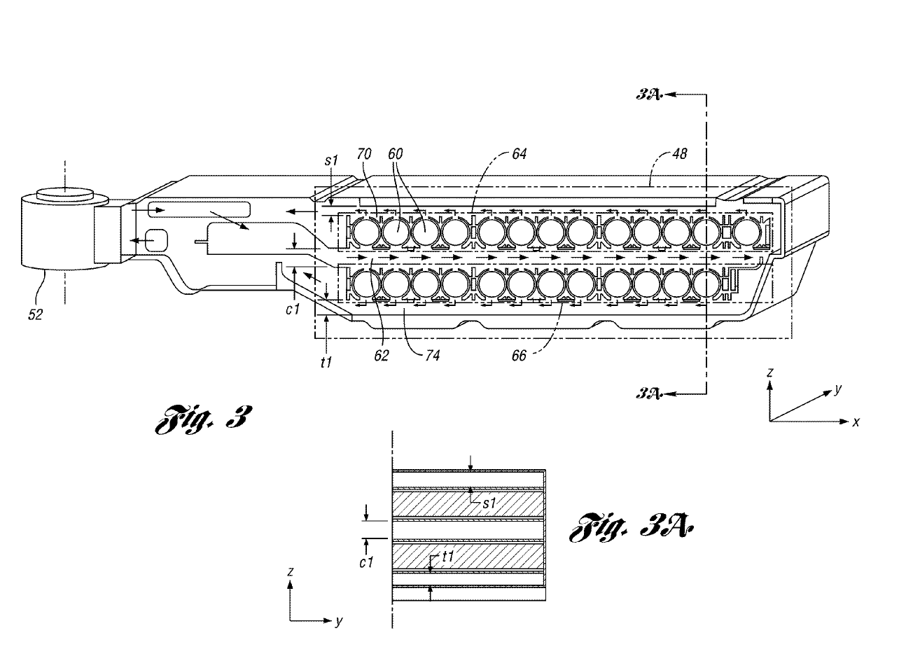

Referring to FIGS. 3 and 3A, the first fan 52 cools the first battery pack 48 by directing air into a first plenum 62. The first plenum 62 separates a first layer 64 of batteries 60 from a second layer 66 of batteries 60. The first plenum 62 has a cross-sectional height c1 at every location in the x-y plane of the first plenum 62. In the embodiment shown in FIG. 3, c1 is generally constant and has a nominal value of 20 mm to facilitate a desired air flow across the batteries 60 of the first battery pack 48. To facilitate a different desired air flow across the batteries 60 of the first battery pack 48, however, c1 can vary along the length of the first plenum 62, i.e., in the x-direction, as well as the width of the first plenum 62, i.e., in the y-direction.

For the embodiment shown in FIG. 3, c1 may increase from a value of 20 mm to 22 mm, decrease from 22 mm to 18 mm, and then increase from 18 mm to 20 mm along a portion of the length of the first plenum 62. Similarly, c1 may decrease from 20 mm to 17 mm and then increase from 17 mm to 23 mm along a portion of the width of the first plenum 62. One range of values for c1 in an embodiment with two (2) layers of batteries 60, such as the embodiment shown in FIG. 3, is 10 mm to 30 mm. The value of c1 at a given location within the x-y plane of the first plenum 62 may be selected, in part, through an analysis of the velocity and pressure of the air at that location.

Referring to FIGS. 4 and 4A, the first plenum 62 may be disposed proximate to a battery pack 48 having only the first layer of batteries 64. In this embodiment, c1 is shown increasing along the length of the first plenum 62 and is shown increasing along a portion of the width of the first plenum 62. In an embodiment with a single layer of batteries 64, such as the embodiment shown in FIG. 4, one range for c1 is 10 mm to 20 mm. Similar to the embodiment of FIGS. 3 and 3A, c1 can vary along the length, width, or length and width of the first plenum 62, or c1 can be generally constant. In the case where c1 is generally constant, one value for c1 is approximately 10 mm. The value of c1 at a given location within the x-y plane of the first plenum 62 may again be selected, in part, through an analysis of the velocity and pressure of the air at that location.

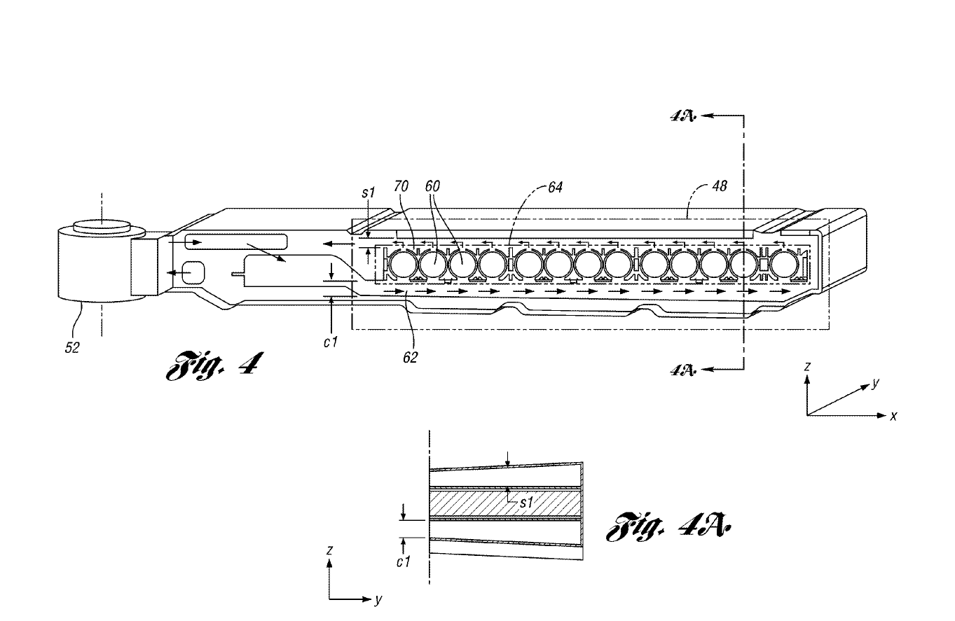

Referring to FIG. 5, the first plenum 62 is configured to further direct the air over each battery 60. The first plenum 62 includes inlet openings 68 that allow air to pass from the first plenum 62 to each battery 60 of the first battery pack 48 (FIG. 3). The air travels over each battery 60 in the first layer 64 to a second plenum 70 through outlet openings 72 in the second plenum 70. The air travels over each battery 60 in the second layer 66 to a third plenum 74 through outlet openings 75 in the third plenum 74.

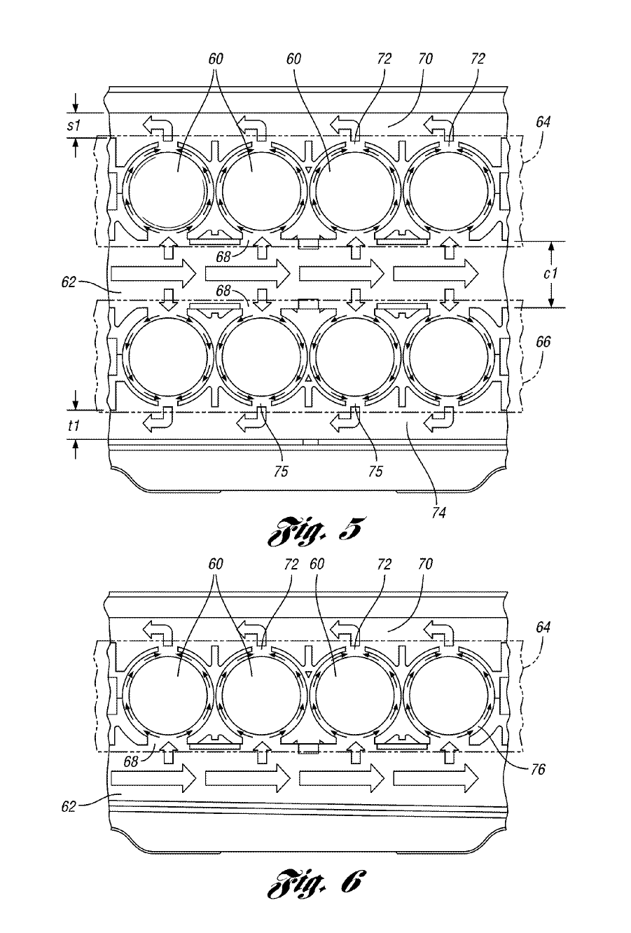

Referring to FIG. 6, the air travels from the first plenum 62 through the inlet openings 68 to each battery 60 in the first layer 64 to the second plenum 70 through outlet openings 72 in the second plenum 70.

Referring again to FIGS. 3 and 3A, the second plenum 70 has a cross-sectional height s1 at every location in the x-y plane of the second plenum 70. In the embodiment shown in FIGS. 3 and 3A, s1 and t1 are generally constant and each have a value of approximately 10 mm in order to provide a desired air flow to the batteries 60 of the first battery pack 48. Similar to the cross-sectional height c1 of the first plenum 62, however, s1 can vary along the length of the second plenum 70, i.e., in the x-direction, as well as the width of the second plenum 70, i.e., in the y-direction, to facilitate a different desired air flow across the batteries 60 of the first battery pack 48.

One range of values for s1 in an embodiment such as the embodiment of FIG. 4, is 10 mm to 20 mm. Likewise, the third plenum 74 has a cross-sectional height t1 at every location in the x-y plane of the third plenum 74. Thus, t1 can vary along the length of the third plenum 74, i.e., in the x-direction, as well as the width of the third plenum 74, i.e., in the y-direction, to facilitate a different desired air flow across the batteries 60 of the first battery pack 48. One range for t1 for the embodiment shown in FIG. 4 is 10 mm to 20 mm. The value of s1 at a given location within the x-y plane of the second plenum 70 and the value of t1 at a given location within the x-y plane of the third plenum 74 are each selected, in part, through an analysis of the velocity and pressure of the air at each respective location.

To further illustrate the manner in which s1 may vary, FIGS. 4 and 4A, show s1 as generally constant along the length of the second plenum 70 and increasing along a portion of the width of the second plenum 70.

Referring again to FIG. 5, the cross-sectional height c1 of the first plenum 62 is approximately equal to the aggregate cross-sectional heights s1 and t1 of the second plenum 70 and third plenum 74, respectively, and the cross-sectional heights s1 and t1 of the second plenum 70 and third plenum 74, respectively, are approximately equal. Configuring the cross-sectional height c1 to be equal to the aggregate cross-sectional heights s1 and t1 provides generally uniform air flow across the batteries 60 of the first battery pack 48. This helps to ensure that each of the batteries 60 is adequately cooled, which helps to eliminate localized heating and increase the life of the power supply apparatus 46.

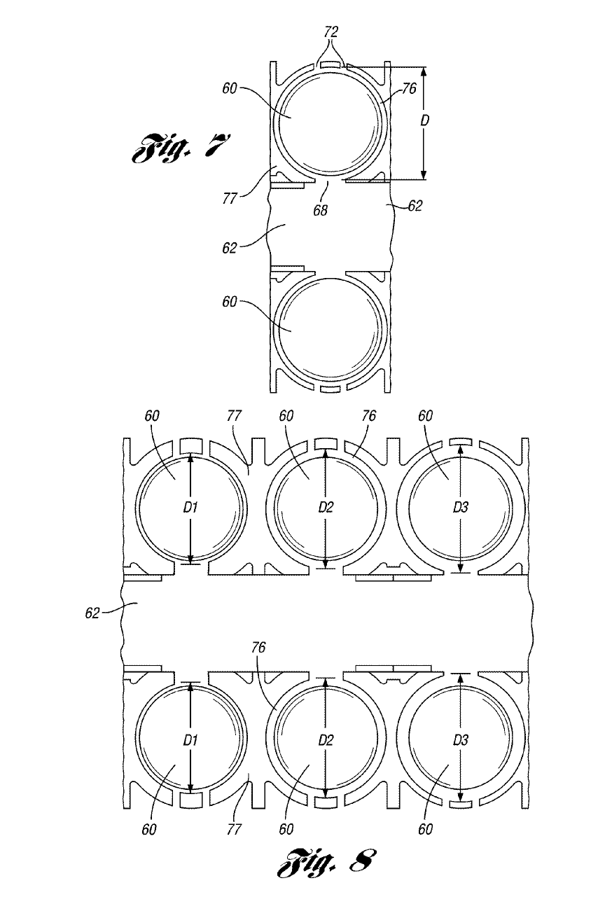

Referring to FIG. 7, each battery 60 resides in a cavity 76 within a structure 77. The cavities 76 each have a diameter D, which, in the embodiment shown in FIG. 7, has a nominal value of approximately 35 mm. The diameter D of each cavity 76 is generally equal to facilitate a desired air flow across the batteries 60.

Referring to FIG. 8, the cavities 76 can have a diameter D1, D2, or D3. In the embodiment shown in FIG. 8, diameter D1 is less than diameter D2 and diameter D2 is less than diameter D3. The diameters D1, D2, and D3, however, need not have this relationship and can be selected to facilitate a desired air flow across each battery 60 of the first battery pack 48. For example, the diameter of those cavities 76 located at a distance further from the first fan 52 may be greater than those located at a distance closer to the first fan 52. The cavities 76 of the embodiment of FIG. 6 can be similarly configured with the diameters D1, D2, and D3 as described above to facilitate the desired air flow across each battery 60 of the first battery pack 48. One range of values for D1, D2, and D3 is approximately 34.5 mm to 36.5 mm. The values for the diameters may be selected, in part, through an analysis of the velocity and pressure of the air within each cavity 76.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A power supply apparatus for a vehicle, comprising:
a first electrical storage unit including a plurality of storage cells;
a second electrical storage unit including a plurality of storage cells, the second electrical storage unit being electrically connected to the first electrical storage unit, thereby forming a single power source;
a first cooling device proximate to the first electrical storage unit and operable to cool at least some of the storage cells of the first electrical storage unit; and
a second cooling device, independently operable from the first cooling device, disposed proximate to the second electrical storage unit and operable to cool at least some of the storage cells of the second electrical storage unit independently from the cooling provided by the first cooling device.

2. The power supply apparatus of claim 1, further comprising a first plenum proximate to the first electrical storage unit and configured to direct air moved by the first cooling device over at least some of the storage cells of the first electrical storage unit.

3. The power supply apparatus of claim 2, wherein the first plenum has a cross-sectional height that is not constant, thereby facilitating generally uniform air flow over at least some of the storage cells of the first electrical storage unit.

4. The power supply apparatus of claim 2, further comprising a second plenum disposed proximate to the first electrical storage unit and configured to receive air moved by the first cooling device after it passes over at least some of the storage cells of the first electrical storage unit.

5. The power supply apparatus of claim 1, wherein the first electrical storage unit further comprises a supporting structure having first and second cavities, and wherein a first storage cell of the storage cells resides in the first cavity and a second storage cell of the storage cells resides in the second cavity, the first cavity having a first diameter and the second cavity having a second diameter different than the first diameter, thereby facilitating generally uniform air flow over the first and second storage cells.

6. The power supply apparatus of claim 1, wherein the first and second cooling devices respectively include first and second fans, and wherein the first fan is controlled independently of the second fan, thereby allowing different air flow rates over each of the electrical storage units.

7. A power supply apparatus, comprising:
a first supporting structure wherein a plurality of batteries is disposed within at least two layers;
a second supporting structure wherein a plurality of batteries is disposed within at least two layers, the batteries of the second supporting structure being electrically connected to the batteries of the first supporting structure;
a first fan proximate the first supporting structure capable of moving air over at least some of the batteries of the first supporting structure; and
a second fan, independently operable from the first fan, disposed proximate the second supporting structure and capable of moving air over at least some of the batteries of the second supporting structure, thereby providing air flow over the second supporting structure that is independent from the air flow over the first supporting structure.

8. The power supply apparatus of claim 7, further comprising an air flow passage proximate to at least one of the layers of the first supporting structure, the air flow passage facilitating the flow of air moved by the first fan over at least some of the batteries of the first supporting structure.

9. The power supply apparatus of claim 8, wherein the air flow passage has a cross-sectional height that is not constant, thereby facilitating generally uniform air flow over at least some of the batteries of the first supporting structure.

10. The power supply apparatus of claim 7, wherein the first supporting structure has first and second cavities, and wherein a first battery of the batteries resides in the first cavity and a second battery of the batteries resides in the second cavity, the first cavity having a first diameter and the second cavity having a second diameter different than the first diameter, thereby facilitating generally uniform air flow over the first and second batteries.

11. The power supply apparatus of claim 7, further comprising:
a first air flow passage disposed between first and second layers of the at least two layers, the first air flow passage facilitating the flow of air moved by the first fan over at least some of the batteries disposed within the first and second layers;
a second air flow passage configured to receive a air moved by the first fan flowing over at least some of the batteries disposed within the first layer, and wherein the first layer is disposed between the first and second air flow passages; and
a third air flow passage configured to receive air moved by the first fan flowing over at least some of the batteries disposed within the second layer, and wherein the second layer is disposed between the first and third air flow passages.

12. The power supply apparatus of claim 11, wherein the first air flow passage has a cross-sectional height, the second air flow passage has a cross-sectional height, and the third air flow passage has a cross-sectional height, and wherein the cross-sectional height of the first air flow passage is at least equal to the aggregate cross-sectional heights of the second and third air flow passages, and wherein the cross-sectional height of the second air flow passage is approximately equal to the cross-sectional height of the third air flow passage.

13. A vehicle comprising:
an integrated power supply apparatus including a first battery pack including a plurality of batteries arranged in at least two layers, and a second battery pack including a plurality of batteries arranged in at least two layers, the second battery pack being electrically connected to the first battery pack;
a first fan proximate the first battery pack and operable to facilitate air flow over at least some of the batteries of the first battery pack; and
a second fan, independently operable from the first fan, disposed proximate the second battery pack and operable to facilitate air flow over at least some of the batteries of the second battery pack.

14. The vehicle of claim 13, further comprising a first air duct disposed between a first and second layer of the first battery pack, the first air duct being configured to direct air moved by the first fan over at least some of the batteries of the first battery pack.

15. The vehicle of claim 14, further comprising:
a second air duct configured to receive air moved by the first fan flowing over at least some of the batteries of the first layer of the first battery pack, and wherein the first layer of the first battery pack is disposed between the first and second air ducts; and
a third air duct configured to receive air moved by the first fan flowing over at least some of the batteries of the second layer of the first battery pack, and wherein the second layer of the first battery pack is disposed between the first and third air ducts.

16. The vehicle of claim 15, wherein the first air duct has a cross-sectional height, the second air duct has a cross-sectional height, and the third air duct has a cross-sectional height, and wherein the cross-sectional height of the first air duct is at least equal to the aggregate cross-sectional heights of the second and third air ducts.

17. The vehicle of claim 15, wherein the first air duct has a cross-sectional height that is not constant, the second air duct has a cross-sectional height that is not constant, and the third air duct has a cross-sectional height that is not constant, thereby facilitating generally uniform air flow over at least some of the batteries.

18. The vehicle of claim 13, wherein the first battery pack further comprises a supporting structure having first and second cavities in the same layer, and wherein a first battery of the batteries resides in the first cavity and a second battery of the batteries resides in the second cavity, the first cavity having a first diameter and the second cavity having a second diameter, the second diameter being different than the first diameter thereby facilitating generally uniform air flow over the first and second batteries.
